(19) United States
(12) Patent Application Publication
(10) Pub. No.: US 2009/0073990 A1
(43) Pub. Date: Mar. 19, 2009

(54) METHOD OF REPLACING A ROUTER IN A LAYER 3 NETWORK

(75) Inventors: Deepak PATIL, Roseville, CA (US); John W. Flick, Sacramento, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/855,790

(22) Filed: Sep. 14, 2007

(51) Int. Cl. H04L 12/56

(52) U.S. Cl. 370/396

(57) ABSTRACT

An apparatus and method of replacing a router in a Layer 3 network, includes configuring a new router to accept a data packet having, as a destination address field, a first media access control address of a replaced router. The method further comprises setting the destination address field of the data packet to the MAC address of the new router, and forwarding the data packet. A router performing the above method comprises configuration logic to configure the router to accept a data packet having, as a destination address, a media access control address of a replaced L3 device; and keep-alive logic adapted to periodically transmit a keep-alive packet to an allocated destination address. The router further comprises packet processing logic that accepts the received data packet, sets the destination address of the data packet to the MAC address associated with the router, and forwards the packet to a destination host.

### BACKGROUND

Contemporary computer networks are based upon a layering of network protocols that include a Layer 2, known as the switching layer, and a Layer 3, known as the routing layer. Because architectures up to Layer 2 allow end station connectivity, it is often practical to construct a Layer 2 network that provides simple, inexpensive and high-performance connectivity for a large number of end devices (hosts). A Layer 2 switching device forwards packets based on the unique Media Access Control (MAC) address of each host within a same network or subnet.

Layer 3, known as the routing layer, allows data transmission between hosts on different networks or subnets. The backbone of contemporary networks is built upon a Layer 3 foundation, and the Internet Protocol (IP) is the premier Layer 3 protocol.

When a host sends a packet to a host on another network, the destination address field of the Layer 2 protocol is populated with the MAC address of the Layer 3 routing device interconnecting the two networks. The router receiving the packet first verifies that the received destination MAC address matches the universally administered address assigned to the router. Once verified the router forwards the packet to the target network using the destination host's MAC address.

Accordingly, the originating host must know the MAC address of the connecting router. In computer networking, Address Resolution Protocol (ARP) is the standard method for translating Layer 3 addresses to Layer 2 addresses, and is based upon an ARP cache that automatically maps the IP address to the MAC address of a device. When an old router is replaced with a new router, the new router generally maintains the IP address of the old router. However, the new router generally comprises a universally administered address uniquely assigned by its manufacturer, different than the MAC address of the original router.

In modern networks, the replacement of a router poses no particular problem. Most hosts are provided with the capability of automatically updating their ARP cache so as to learn the MAC address of the new router. This is normally accomplished when the router is brought on line, at which time it transmits an ARP announcement (also known as a “Gratuitous ARP”), which is a packet containing a sender hardware address (SHA) and a sender protocol address (SPA) for the new device, i.e., the router, with a Target Protocol address (TPA) equal to the SPA. Such a request is not intended to solicit a reply, but merely updates the ARP information of hosts receiving the packet.

However, there are literally thousands of legacy hosts still in operation that are “hardwired” for a particular router MAC address and are unable to automatically update their ARP cache. Router replacement in these networks may require each host to be individually reconfigured at significant cost in time and money.

### DESCRIPTION OF THE DRAWINGS

One or more embodiments are illustrated by way of example, and not by limitation, in the figures of the accompanying drawings, wherein:

FIG. 1 is a high-level functional block diagram of a computer network according to an embodiment;

FIG. 2 is a message sequence chart illustrates the routing of packets, according to the embodiment of FIG. 1;

FIG. 3 is a flowchart illustrating a method, according to an embodiment; and

FIG. 4 is a flowchart illustrating another method, according to an embodiment.

### DETAILED DESCRIPTION

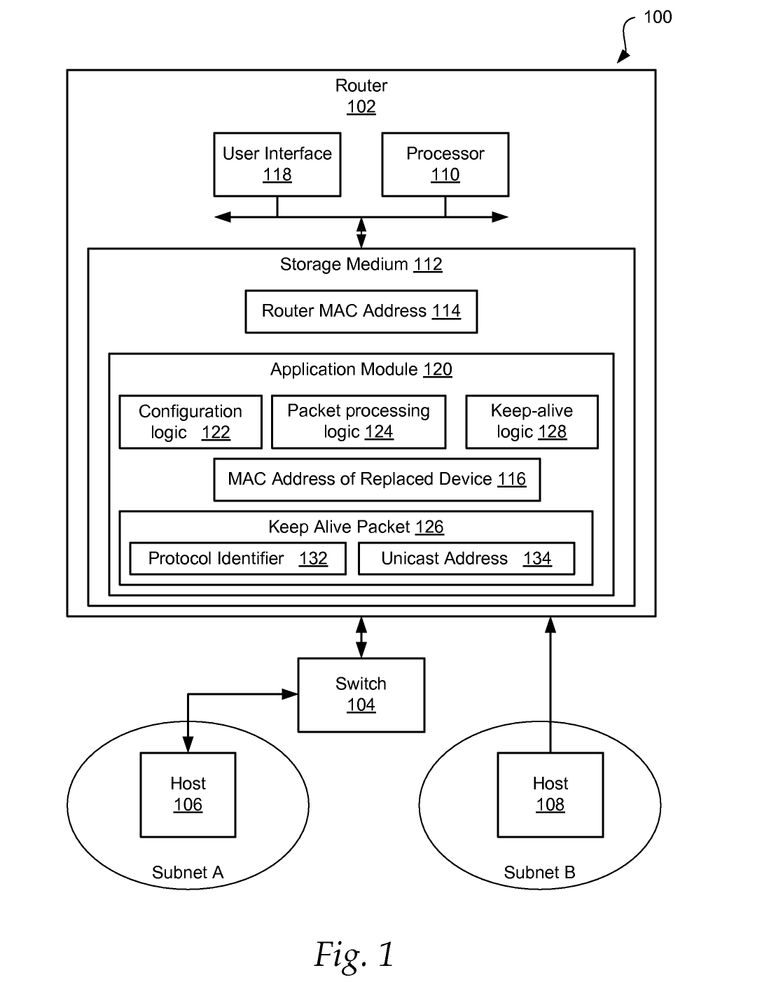

FIG. 1 illustrates a high-level functional block diagram of a computer network 100 based upon a Layer 3 foundation. In some embodiments, network device 102 is a network router, an ETHERNET switch, a bridging device, or other network traffic handling device, etc., which performs Layer 3 (L3) routing. Furthermore, in the embodiment shown, router 102 is a newly installed router and replaces an older router, not shown.

Network switching device 104 is a Layer 2 (L2) switch that forwards packets between host devices within the same subnet using the unique MAC address associated with host device. Because host device 106 and 108 are configured on separate subnets A and B, packets from one host transmitted to the other host are routed through router 102.

Furthermore, according to an embodiment, hosts 106 and 108 are hardwired to route packets through a network device with a predetermined MAC address, which in this embodiment is referred to as the “old” router.

Accordingly, apparatus and methods are herein disclosed for allowing host devices 106, 108 which are each members of different sub networks, subnets A and B, respectively, to continue transmitting packets to the old MAC address and communicate via new router 102 without impacting the host devices. The method comprises: transmitting information to switch 104 to allow it to correctly forward packets having a destination address of the replaced router, i.e., the old MAC address, to router 102; and configuring router 102 to accept and forward the packets addressed to the old MAC address.

As illustrated in FIG. 1, router 102 comprises a processor 110 configured to execute an application module 120 residing on a storage medium 112. Router 102 comprises a universally administered MAC address 114, which in at least one embodiment, is stored in storage medium 112.

In some embodiments, application module 120 provides L3 functionality, comprising at least logical partitioning of subnets, scalability, security, Quality of Service, bandwidth reservation, and packet delay bounding. In addition to these standard L3 functions, configuration logic 122 of application module 120 is further configured to accept packets intended for a MAC address 116 not inherently associated with router 102. Specifically, configuration logic 122 is configured with the MAC address, i.e., MAC address 116, of the router that was replaced by router 102. In at least some embodiments, configuration logic 122, in conjunction with user interface 118, allows a system administrator to configure router 102. In at least some embodiments, user interface 118 is a command line interface (CLI). In at least some other embodiments, the router is configured remotely by a networked device.

After the old router is removed, and before new router 102, with the herein disclosed apparatus and methods, is installed, switch 104 will no longer receive updates as to which port to transmit packets destined to old MAC address 116. Without this knowledge, upon receipt of a packet from host 106, 108 with MAC address 116 in the source address field, switch 104 broadcasts on all ports waiting for a response that will inform switch 104 where to forward the packet. Without the apparatus and methods disclosed herein, that response will not be forthcoming.

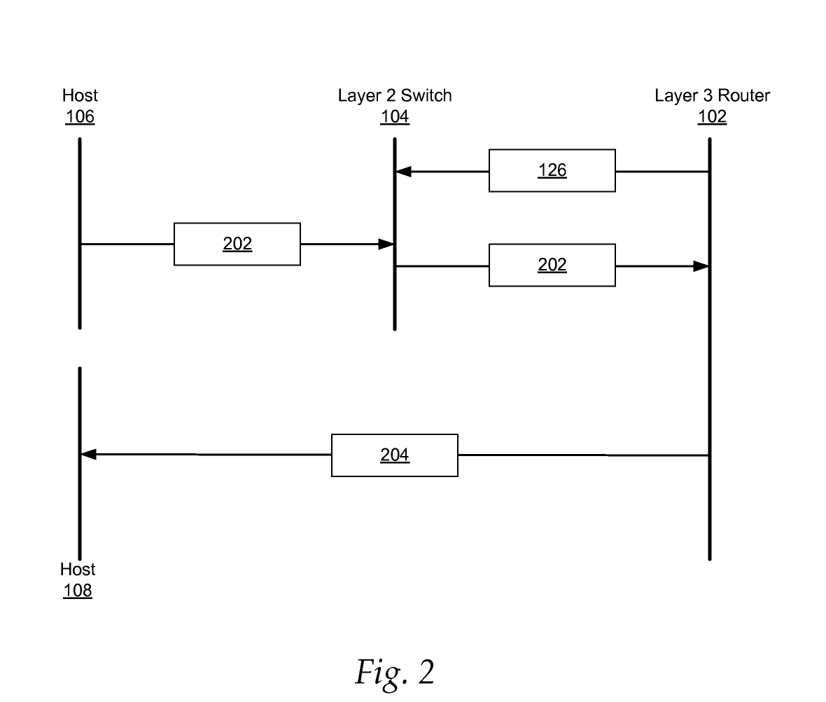

FIG. 2 illustrates a message sequence whereby packet 202 from host 106, intended for host 108 is processed according to the apparatus and methods disclosed herein. Packet 202 comprises the IP address of host 108 in the destination field of the Layer 3 portion of the packet and the MAC address, i.e., MAC address 116, in the destination field of the Layer 2 portion of the packet.

Once installed and configured with MAC address 116 of the old router, processor 110 executes keep-alive logic 128, causing router 102 to periodically send a keep-alive packet 126 to switch 104 at a configurable time interval. Upon receipt of keep-alive packet 126, switch 104 reconfigures itself to forward received packets, having MAC address 116 as the destination address field, to router 102. Accordingly, broadcasting by switch 104 is prevented.

In one embodiment, keep-alive packet 126 has the format of an extended Organizationally Unique Identifier (OUI) Ethernet frame that contains an OUI extended ethertype (88B7) and a new protocol identifier in the five octet protocol identifier field, for example, “08:00:09:00:02.” Ethertype value 88B7, is available for public use, and prototype and vendor-specific protocol development, as defined in Amendment 802a to IEEE Std 802. The specific format of keep-alive packets 126, along with a registered protocol identifier 132, helps ensure any future network debugging support. Furthermore, the destination address of keep-alive packet 126 is set to a specifically allocated unicast MAC address 134 to ensure that switch 104 does not broadcast keep-alive packet 126 to a connected host, e.g., 106.

As previously disclosed, in one embodiment, upon receipt of packet 126, switch 104 learns, i.e., switch 104 is reconfigured, to forward received packets having MAC address 116 as the destination address field to router 102. After switch 104 has learnt to forward packet 202 to router 102, router 102 accepts the packets and processes them accordingly. Packet processing logic 124, when executed by processor 110, accepts packet 202 and validates the destination address, comparing the MAC address in the destination field with MAC address 116 configured by the user and stored in storage medium 112.

Upon validation of packet 202, packet processing logic modifies the source address field of the packet, replacing the old MAC address 116 with the factory assigned MAC address 114 of L3 router 102, and forwards the reconstructed packet 204 to host 108.

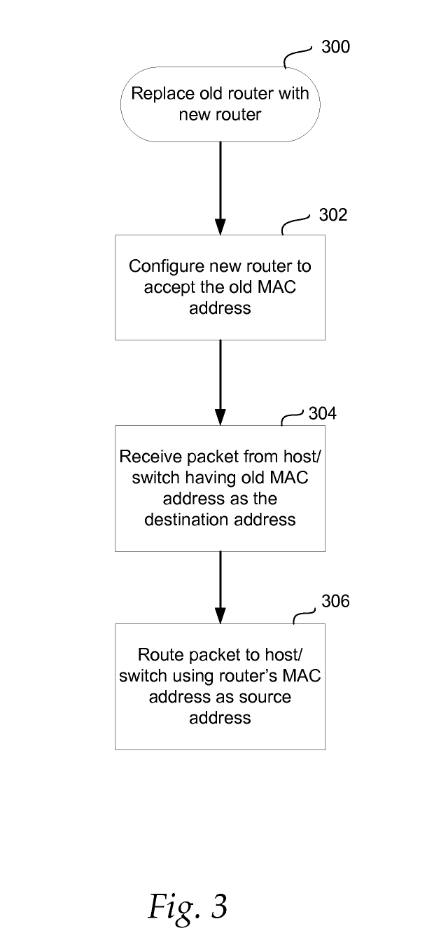

FIG. 3 illustrates a high level flowchart of an embodiment executing in router 102, wherein processor 110 executes application module 120 to accept and forward packets 202 comprising a MAC address of a replaced router in the destination address field of the packet 202. After an original router has been replaced (300) with a router 102, functionality 302 comprises configuring a new router (102) to accept a data packet having, as a destination address field, a first media access control (MAC) address (116) of a replaced router.

Functionality 304 includes receiving on the new router (102) the data packet and verifying that the new router is configured to accept the data packet. At block 306, router 102 forwards the data packet, setting the source address field of said data packet to the MAC address (114) of the new router.

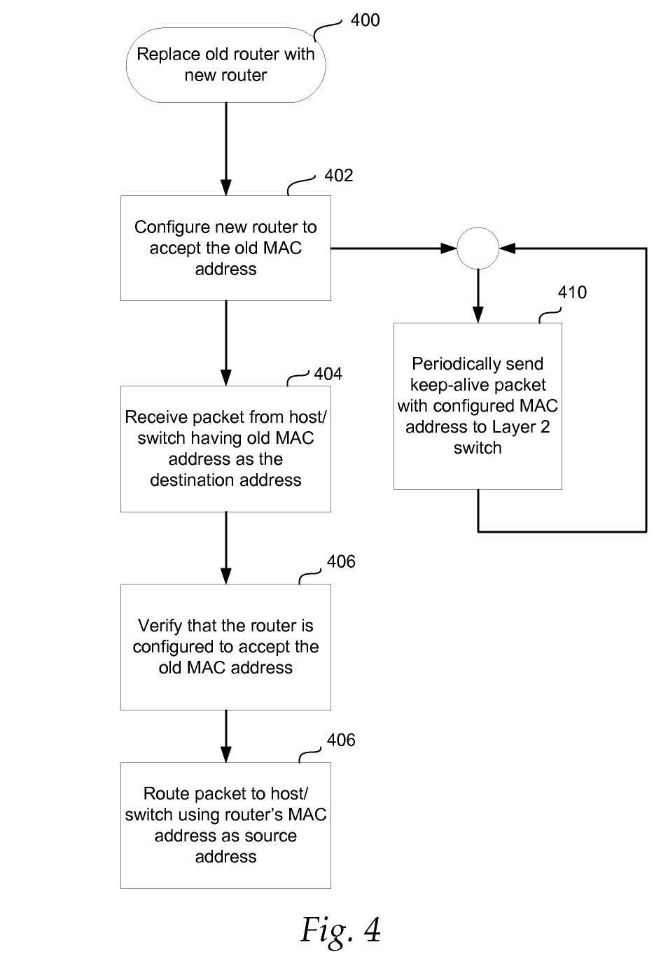

FIG. 4 illustrates a flowchart of another embodiment executing in router 102, wherein processor 110 executes application module 120 to accept and forward packets 202 comprising a MAC address of a replaced router in the destination address field of the packet 202. After an original router has been replaced (400) with router 102, functionality 402 comprises configuring router 102 to accept a packet with the MAC address of a replaced router, i.e., MAC address 116. After configuration, keep-alive functionality 410 periodically sends keep-alive packet 126 at a configurable time period, so that switch 104 may learn to forward packet 202 to router 102.

Packet processing logic 124 receives (404) packet 202 from switch 104, verifies (406) that router 102 is configured to process packet 202 based upon the MAC address 116 stored in storage medium 112, and routes (408) packet 204 to host 108, with the source address field of packet 204 set to the MAC address of the router, i.e., MAC address 114.

The functions of methods described in connection with the embodiments disclosed herein, i.e., application module 120, may be embodied directly in hardware or in a set of executable instructions stored in a storage medium 112 executed by one or more processors 110. Storage medium 112 may comprise RAM memory, flash memory, ROM memory, PROM memory, EPROM memory, EEPROM memory, registers, hard disk, a removable disk, a CD-ROM, or another form of storage medium. In at least some embodiments, storage medium 112 is integral to processor 110. In some further embodiments, processor 110 and one or more storage medium 112 may reside in an ASIC.

The functions and methods described above permit seamless migration to new layer 3 routers with no impact on host devices.

What is claimed is:

1. A method of replacing a router in a Layer 3 network, comprising:
configuring a new router to accept a data packet having, as a destination address field, a first media access control (MAC) address of a replaced router;
receiving on the new router the data packet and verifying that the new router is configured to accept the data packet; and
forwarding the data packet, setting the source address field of said data packet to the MAC address of the new router.

2. The method of claim 1, further comprising periodically transmitting, at a configurable interval, a keep-alive packet to an allocated destination address, the keep-alive packet teaching a Layer 2 switch where to forward the data packet.

3. The method of claim 2, wherein transmitting the keep-alive packet includes transmitting a source address corresponding to the MAC address of the replaced router.

4. The method of claim 2, wherein periodically transmitting the keep-alive packet comprises periodically transmitting an Organizational Unique Identifier (OUI) extended ethertype frame and a predetermined protocol identifier.

5. At least one processor, the processor configured in a Layer 3 network device to perform the actions of:
transmitting, at a configurable interval, a keep-alive packet to an allocated destination address, the keep-alive packet comprising a source address corresponding to the MAC address of a replaced Layer 3 device;
configuring the device to accept a data packet having, as a destination address field, a media access control (MAC) address of the replaced Layer 3 device;
receiving on the network device the data packet and verifying that the network device is configured to accept the data packet; and
forwarding the data packet, changing the source address field of the data packet to a uniquely assigned MAC address of the network device.

6. A computer computer-readable medium comprising:
a first set of codes for causing an existing Layer 3 (L3) device to transmit, at a configurable interval, a keep-alive packet to an allocated destination address, the keep-alive packet comprising a source address corresponding to a MAC address associated with a replaced Layer 3 (L3) device;
a second set of codes for causing the existing L3 device to accept a data packet having, as a destination address field, a media access control (MAC) address of the replaced L3 device;
a third set of codes for causing the existing L3 device to receive the data packet and verify that the existing L3 device is configured to accept the data packet; and
a fourth set of codes for causing the existing L3 device to forward the data packet, setting a source address field of the data packet to a uniquely assigned MAC address of the existing L3 device.

7. A network device, comprising:
a MAC address uniquely associated with the network device;
a processor;
a storage medium accessible by the processor;
an application module stored in the storage medium, the application module configured to be executed by the processor, the application module including:
configuration logic adapted to configure the network device to accept a data packet having, as a source address, a media access control (MAC) address of a replaced network device;
keep-alive logic adapted to periodically transmit a keep-alive packet to an allocated destination address, the keep-alive packet comprising the MAC address of the replaced network device;
packet processing logic adapted to allow the network device to accept a received data packet having, as a destination address, the MAC address of the replaced network device; set the source address of the data packet to the MAC address associated with the network device; and forward the data packet to a destination host.

8. The network device of claim 7, wherein the keep-alive packet further comprises:
a destination MAC address field set with a predetermined allocated MAC address;
an extended Organizationally Unique Identifier (OUI) Ethernet frame; and
a predetermined protocol identifier.

9. A keep-alive packet configured to be transmitted by an existing Layer 3 (L3) routing device to a Layer 2 (L2) switching device, the keep-alive packet comprising:
an extended Organizationally Unique Identifier (OUI) Ethernet frame;
a source MAC address of a previous L3 device;
a destination MAC address field set with a predetermined allocated MAC address; and
a predetermined protocol identifier;
wherein the keep-alive packet is configured to teach the L2 switching device to forward a data packet having a destination address field set to the MAC address of the previous L3 device.
